(19) United States
(12) Patent Application Publication
(10) Pub. No.: US 2016/0297408 A1
(43) Pub. Date: Oct. 13, 2016

(54) REGENERATIVE BRAKE METHOD AND SYSTEM

(71) Applicant: PARKER-HANNIFIN CORPORATION, Cleveland, OH (US)

(72) Inventors: Michael Gallagher, Cleveland, OH (US); Prasad Venkiteswaran, Dublin, OH (US); Bradley A. Slakans, Olive Branch, MS (US); Yisheng Zhang, Dublin, OH (US)

(21) Appl. No.: 14/777,938

(22) PCT Filed: Mar. 26, 2014
(86) PCT No.: PCT/US2014/031798

§ 371 Date: Sep. 17, 2015

Related U.S. Application Data
(60) Provisional application No. 61/807,459, filed on Apr. 2, 2013.

(51) Int. Cl. B60T 1/10; B60K 6/12; B60W 30/18; B60W 10/04; B60W 10/188

(52) U.S. Cl. CPC B60T 1/10; B60W 10/04; B60W 10/188; B60W 30/18127; B60K 6/12; B60W 2710/18; B60W 2510/24; B60W 2520/10; B60W 2540/12

(57) ABSTRACT

A vehicle 100 (FIG. 1) includes a braking system 100a (FIG. 2) that includes a foundation braking system 111 and a hydraulic braking system 112. According to method 100b (FIGS. 3 and 4), system controller 117 (FIG. 2) at successive steps 120-127 determines when hydraulic regenerative braking system 112 cannot provide full commanded braking torque and acts through proportional treadle valve 116a to provide a proportional transition between an isolated hydraulic braking mode and an isolated foundation braking mode. According to methods 200b (FIGS. 7-8) and 200b (FIGS. 9-10), proportional braking is approximated. According to method 300 (FIG. 11), hydraulic braking is reduced at the initiation of a braking event based upon the estimated kinetic energy of the vehicle and available capacity for storing that energy.

### CROSS REFERENCE TO RELATED APPLICATIONS

The present patent application is related to U.S. provisional patent application Ser. No. 61/641,467 filed May 2, 2012 and international PCT patent application no. PCT/2013/023048 filed Jan. 25, 2013, the disclosures of which are incorporated herein by reference in their entirety. The present patent application claims the benefit of the filing date of U.S. provisional patent application Ser. No. 61/807,459, filed Apr. 2, 2013.

### TECHNICAL FIELD

This invention relates generally to brake methods and systems. More specifically, this invention relates to regenerative brake methods and systems for hybrid vehicles, and to components and assemblies that may be used with such vehicles and elsewhere.

### BACKGROUND OF THE INVENTION

Hydraulic hybrid vehicles may include a vehicle prime mover such as an internal combustion engine, at least one hydraulic pump motor unit, at least one high pressure hydraulic fluid accumulator, and a vehicle foundation brake system. The internal combustion engine and the hydraulic pump motor unit are connected to a gear set, and the gear set spots power from the internal combustion engine and from the hydraulic pump motor unit in a motoring mode to rotate a drive shaft and propel the vehicle. The foundation brake system is the conventional or primary brake system of the vehicle, which may for example typically be a conventional air brake system usually found in larger vehicles or a conventional hydraulic master cylinder brake system usually found in smaller vehicles or a vacuum brake system or other system.

Braking the vehicle may be accomplished in prior art braking systems using both the hydraulic pump motor unit and the foundation brake system. The pump motor unit during braking may operate in a pumping mode to provide hydraulic braking torque to slow the ground speed of the vehicle. In the pumping mode, the pump motor unit pumps hydraulic fluid into the accumulator, to capture and store the braking energy for later use in the motoring mode to propel the vehicle. The captured energy may be stored in the accumulator, which provides an energy storage device to power the hydraulic pump motor unit in the motoring mode.

During braking, it is desirable for the pump motor unit operating in its pumping mode to capture as much hydraulic braking energy as reasonably possible and to transfer that energy to the hydraulic accumulator for storage and later use, to reduce fuel consumption by the internal combustion engine. The accumulator has a finite fluid volumetric size and a finite maximum pressure level, and therefore has a finite maximum energy storage capacity. When that storage capacity is reached during braking, there are two options for continued braking of the vehicle. One option is to run the hydraulic pump motor unit output flow across a pressure relief valve, to dissipate the energy being generated by the hydraulic pump motor unit. This option can be used preferably for only limited amounts of braking, due to heat build-up in the hydraulic fluid. The second option is to use the vehicle foundation brake system. This option is used when greater amounts of braking energy must be dissipated to brake the vehicle when the hydraulic accumulator has reached or is approaching its maximum energy storage capacity.

During braking, prior art hydraulic hybrid vehicle braking methods and systems may operate in various modes. For example, in an isolated hydraulic mode, only the hydraulic braking is used to brake the vehicle. This mode may be called an “isolated hydraulic braking mode.” Further, it may be necessary to transition during a “transition braking mode” from the isolated hydraulic braking mode to a “combination braking mode” or “blended braking mode” that provides combined hydraulic braking and foundation braking and/or to an “isolated foundation braking mode” in which only foundation braking is used.

In such prior art hydraulic hybrid braking methods and systems, technical problems are presented to provide smoother braking operation during all operating modes, to provide maximum hydraulic braking and maximum energy capture and storage, to provide minimum hydraulic fluid heat build-up, and to reduce system complexity and cost.

### SUMMARY OF THE INVENTION

The present invention addresses these and other technical problems in one embodiment by providing a hydraulic hybrid vehicle braking system that commands and provides proportional hydraulic braking and foundation braking. The proportional control is based upon inputs to a system electronic controller that include accumulator energy storage condition and vehicle ground speed and outputs from the controller to hydraulic pump controls and to an electrically operated foundation brake pressure proportional control valve. The invention further addresses these and other technical problems another embodiment by providing a hydraulic hybrid vehicle braking system that commands and provides approximate proportional hydraulic braking and foundation braking. The approximate proportional control is based upon the above inputs to the system electronic controller, outputs from the controller to the hydraulic pump controls, and foundation brake torque determined by an operator controlled conventional foundation brake system pedal or treadle valve. The invention further addresses these and other technical problems in another embodiment by providing a hydraulic hybrid vehicle braking system that determines kinetic energy of the vehicle and hydraulic energy storage capacity at initiation of a braking event, and commands isolated hydraulic braking mode or combination braking mode based upon the sensed inputs.

More specifically, the invention according to at least one embodiment provides a method of controlling a vehicle braking system which may comprise the steps: providing a regenerative braking system with an energy storage device, and an energy to mechanical torque to energy conversion device connected to wheels of the vehicle to provide regenerative braking torque to wheels of the vehicle and connected to the energy storage device to store energy generated by the regenerative braking torque; providing a foundation braking system with foundation braking actuators having fluid chambers to provide foundation braking torque to wheels of the vehicle; providing an electronic controller in communication with each of the regenerative braking system and the foundation braking system; storing in the controller a known relationship between foundation braking actuator chamber pressure and foundation braking torque; sensing an input command based upon operator input and translating operator input to a total commanded braking torque; sensing the available energy storage capacity of the energy storage device; calculating a desired amount of braking torque for each of the regenerative braking torque and the foundation braking torque during a braking event based at least in part upon available energy storage capacity and vehicle ground speed; communicating to the regenerative braking system a commanded regenerative braking torque to achieve the desired regenerative braking torque; and communicating to the foundation braking system a commanded foundation braking torque to achieve the desired foundation braking torque.

According to at least one embodiment, the invention further provides a method of controlling a vehicle braking system, which may comprise: determining if total commanded braking torque is less than available regenerative braking torque based upon sensed available energy storage capacity of the energy storage device; if yes, then entering an isolated regenerative braking mode in which substantially all braking torque is applied by the regenerative braking system and foundation braking torque is substantially zero and pressure in foundation braking system chambers is substantially zero atmospheric.

According to at least one embodiment, the invention further provides a method of controlling a vehicle braking system, which may comprise: if no, then using the electronic controller to calculate and command required pressure in foundation braking system chambers to provide foundation braking torque substantially equal to the difference between total commanded braking torque and available regenerative braking system braking torque at current regenerative braking system available energy storage capacity, and maintaining net braking torque substantially equal to total commanded braking torque by constantly varying the regenerative braking system braking torque.

According to at least one embodiment, the invention further provides a method of controlling a vehicle braking system, which may comprise: after entering isolated regenerative braking mode repeatedly determining if total commanded braking torque is less than available regenerative braking torque based upon sensed energy storage capacity of the energy storage device; if yes, then continuing in isolated regenerative braking mode; if no, then commanding required pressure in foundation braking system chambers to provide foundation braking torque substantially equal to difference between total commanded braking torque and available regenerative braking system braking torque at current regenerative braking system available energy storage capacity; and maintaining net braking torque by constantly varying the regenerative braking system braking torque.

According to at least one embodiment, the invention further provides a method of controlling a vehicle braking system, wherein the calculating a desired amount of braking torque for each of the regenerative braking torque and the foundation braking torque during a braking event may be based at least in part upon pressure in the foundation braking actuator chamber. Pressure in the foundation braking actuator chamber may be sensed without measuring pressure by sensing operator input or by measuring pressure with a pressure sensor.

According to at least one embodiment, the invention further provides a method of controlling a vehicle braking system, wherein the calculating a desired amount of braking torque for each of the regenerative braking torque and the foundation braking torque during a braking event may include calculating by operation of the controller a proportional amount of braking torque for each of the regenerative braking torque and the foundation braking torque. The method may include going to proportional braking mode upon exiting isolated regenerative braking mode; in proportional braking mode, the operator input communicates a total commanded torque to the system controller; the system controller may determine the available hydraulic torque based upon system inputs including available energy storage device storage capacity; the controller may also determine the torque difference between the total commanded torque from the operator input and the actual regenerative torque commanded, and command a proportional valve to provide pressure to the chamber that will result in the torque difference being applied through the foundation braking system; the controller may continue to command both regenerative braking based upon regenerative system requirements and foundation braking based upon this difference, to allow use of maximum available regenerative braking.

According to at least one embodiment, the invention further provides a method of controlling a vehicle braking system, wherein the foundation braking system may be an air braking system, and the proportional valve may be a proportional air pressure valve that controls the pressure in the chamber in response to controller input.

According to at least one embodiment, the invention further provides a method of controlling a vehicle braking system, wherein the calculating a desired amount of braking torque for each of the regenerative braking torque and the foundation braking torque may include after exiting an isolated regenerative braking mode allowing pressure to build in the foundation braking actuator chamber to create a foundation braking torque, monitoring the pressure, and derating the regenerative braking torque by the foundation braking torque implied by the pressure. The method may include blocking foundation braking torque from the front wheels of the vehicle during a first stage of the transition mode. The method may include opening foundation braking torque to the front wheels of the vehicle during a second stage of the transition mode.

According to at least one embodiment, the invention further provides a method of controlling a vehicle braking system, comprising adding a blended torque to the total commanded braking torque to provide a total actual braking torque; commanding the regenerative braking system to provide regenerative braking torque substantially equal to the total actual braking torque during an isolated regenerative braking mode; commanding the foundation braking system to provide substantially the total commanded braking torque and decreasing the commanded regenerative braking torque during a transition braking mode; and maintaining the total actual braking torque substantially equal to the blended torque plus the total commanded braking torque during and after the transition braking mode. The method may include commanding the foundation braking system to provide a foundation braking torque substantially equal to the total commanded braking torque and commanding the regenerative braking system to provide a regenerative braking torque substantially equal to the blended torque after the transition braking mode. The method may include decreasing the commanded regenerative braking torque during the transitory braking mode substantially to the blended torque.

According to at least one embodiment, the invention further provides a method of controlling a vehicle braking system, which may comprise sensing the vehicle ground speed and using the vehicle ground speed to indicate the approximate kinetic energy of the vehicle; comparing the energy storage device available energy storage capacity and the kinetic energy at the initiation of a brake event; if energy storage capacity is greater than kinetic energy at the initiation of a braking event, then command the regenerative braking system to provide regenerative braking of the vehicle; if energy storage capacity is less than kinetic energy at the initiation of a braking event, then command the regenerative system to provide actual regenerative braking torque in an amount to approximately fill the energy storage device capacity over time from initiation of the braking event to projected 0 ground speed at a given total commanded braking torque at initiation of the braking event; and commanding the foundation braking system to provide foundation braking torque equal to the difference between the total commanded braking torque and the actual regenerative braking torque.

According to at least one embodiment, the invention further provides a method of controlling a vehicle braking system, wherein the regenerative braking system may be a hydraulic regenerative braking system, the energy storage device may be a hydraulic accumulator, and the conversion device may be a hydraulic pump motor unit.

According to at least one embodiment, the invention further provides a method of controlling a vehicle braking system comprising the steps: providing a regenerative braking system with an energy storage device having an energy storage capacity and a braking torque to energy to braking torque conversion device connected to wheels of the vehicle to provide regenerative braking torque to wheels of the vehicle and connected to the energy storage device to store energy expended to provide the regenerative braking torque; providing a foundation braking system with foundation braking actuators to provide foundation braking torque to wheels of the vehicle; providing an electronic controller in communication with each of the regenerative braking system and the foundation braking system; sensing the available energy storage capacity of the energy storage device; sensing the vehicle ground speed and using the vehicle ground speed to calculate the approximate kinetic energy of the vehicle; comparing the energy storage device available energy storage capacity and the kinetic energy at the initiation of a brake event; if energy storage capacity is greater than kinetic energy at the initiation of a braking event, then command the regenerative braking system to provide isolated regenerative braking of the vehicle; if energy storage capacity is less than kinetic energy at the initiation of a braking event, then command the regenerative system to provide actual regenerative braking torque in an amount to approximately fill the energy storage device capacity over time from initiation of the braking event to projected 0 ground speed at a given total commanded braking torque at initiation of the braking event; and commanding the foundation braking system to provide foundation braking torque equal to the difference between the total commanded braking torque and the actual regenerative braking torque.

According to at least one embodiment, the invention further provides a system for carrying out any of the foregoing methods and a vehicle having such system.

These and other features of the invention are more fully described and particularly pointed out in the description and claims set out below, and this Summary is not intended to identify all key features or essential features of the claimed subject matter. The following description and claims and the annexed drawings set forth in detail certain illustrative embodiments of the invention, and these embodiments indicate but a few of the various ways in which the principles of the invention may be used.

### BRIEF DESCRIPTION OF THE DRAWINGS

Embodiments of this invention will now be described in further detail with reference to the accompanying drawings, in which:

FIG. 1 is a schematic diagram of a wheeled land vehicle that includes a brake method and system according to the present invention;

FIG. 2 is a more detailed schematic representation of a portion of the vehicle illustrated in FIG. 1, showing the vehicle as a three axle wheeled land vehicle that includes a brake method and system according to a first embodiment of the present invention, and showing a portion of the vehicle brake system;

FIG. 3 is a flow chart, illustrating a method and system for proportional braking in the system such as shown in FIG. 2;

FIG. 4 is a graph illustrating the method and system for proportional braking in the system such as shown in FIGS. 2 and 3;

FIG. 5 is a schematic representation of a three axle wheeled land vehicle that includes the method and system according to a second embodiment of the present invention, showing a portion of the vehicle brake system;

FIG. 6 is a schematic representation of a two axle wheeled land vehicle that includes the method and system according to the second embodiment of the present invention, showing a portion of the vehicle brake system;

FIG. 7 is a flow chart illustrating a first alternative method and system for braking in the second embodiment system such as shown in FIGS. 5 and 6;

FIG. 8 is a graph illustrating the first alternative for the second embodiment method and system for braking in the system such as shown in FIGS. 5-7;

FIG. 9 is a flow chart illustrating a second alternative for the second embodiment method and system for braking in the system such as shown in FIGS. 5 and 6;

FIG. 10 is a graph illustrating the second alternative for the method and system for braking in the system such as shown in FIGS. 5-6 and 9;

FIG. 11 is a flow chart, illustrating a method and system for a third embodiment of the present invention.

### DETAILED DESCRIPTION OF THE DRAWINGS

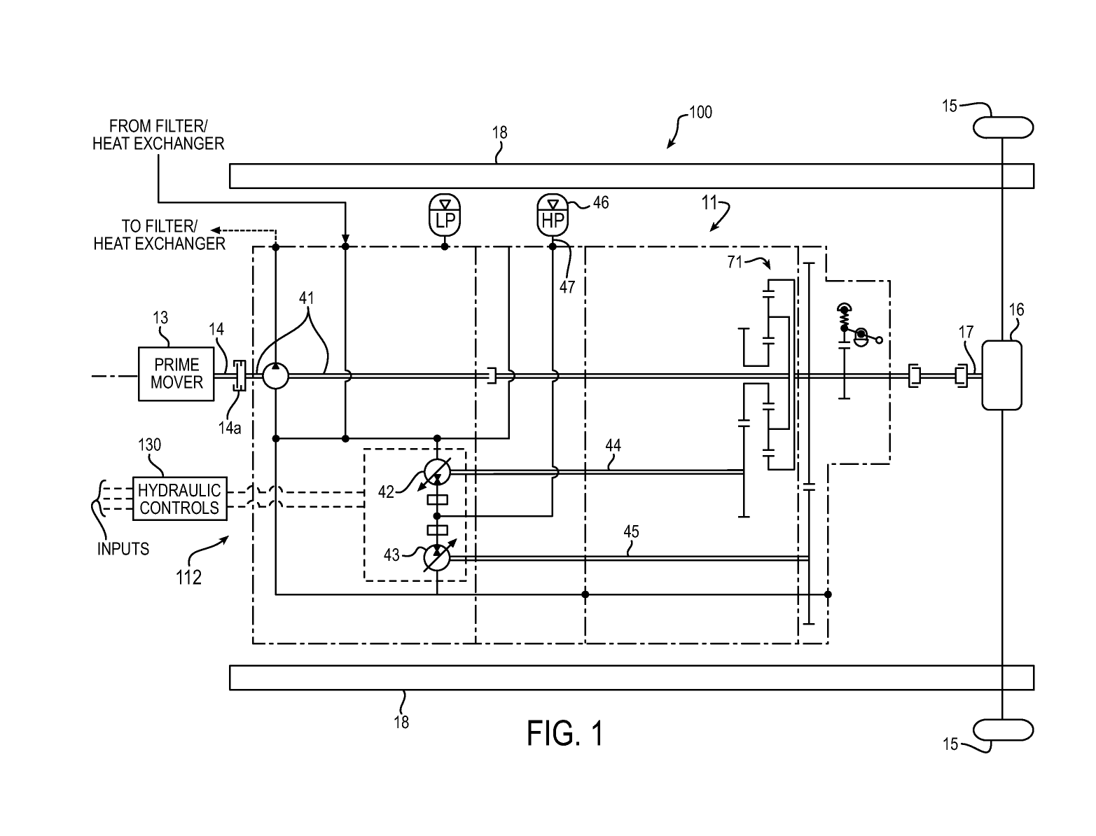

Referring now to the drawings in greater detail, FIG. 1 illustrates an object 100 having a compact hydromechanical powersplit transmission 11 that is further described in the PCT patent application cited above in the Cross Reference to Related Patent Applications. The object 100 can be any object that uses a transmission for transmitting energy or converting energy to rotational movement. In the preferred embodiment described below, the object 100 is a wheeled land vehicle such as an on-highway truck. The vehicle 100 includes a prime mover 13, which in the preferred embodiment is an internal combustion engine such as a gasoline or diesel or natural gas or other fuel engine, or a fuel cell or other prime mover, and an engine drive shaft 14. The vehicle 10 further includes drive wheels 15, a differential 16, and a differential drive shaft 17. The vehicle 100 also includes frame rails 18, which are longitudinally extending beams, which may be steel or other suitable structural material, to which the body (not shown), prime mover 13, drive shaft 14, vehicle suspension components (not shown), differential 16 and other components of the vehicle 10 are mounted in a conventional well know manner.

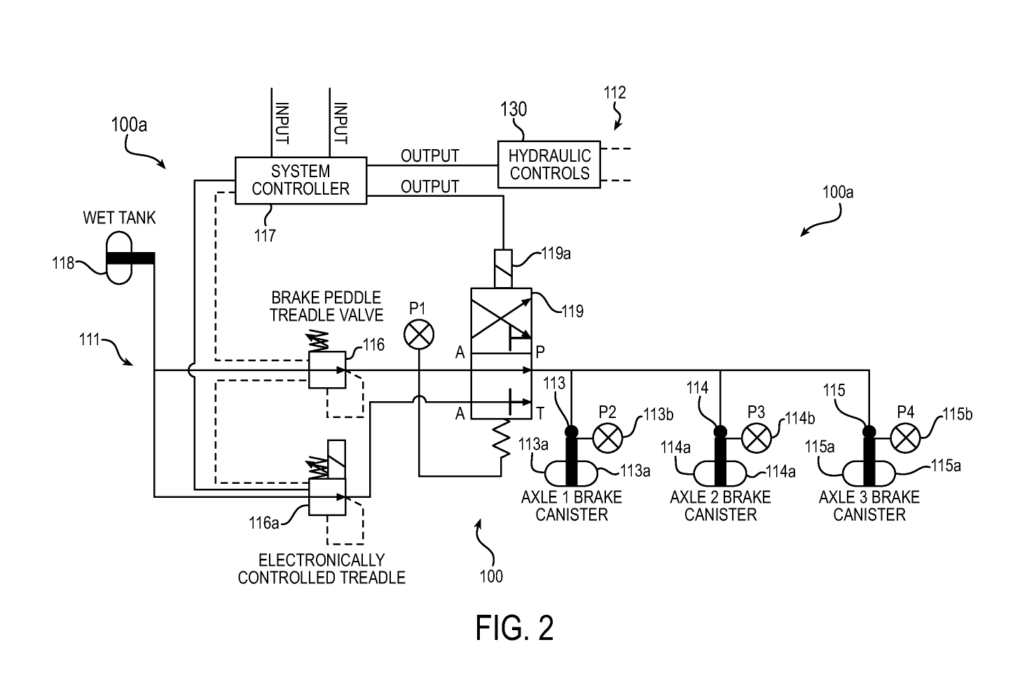

A longitudinally extending prime mover input shaft or mechanical drive shaft 41 is rotatably connected to the prime mover 13, so that the prime mover 13 drives the input shaft 41 and causes the input shaft 41 to rotate when the prime mover 13 is running. The term rotatably connected means that components rotate together or are drivingly connected. A primary hydraulic pump motor unit 42 and a secondary hydraulic pump motor unit 43 in the preferred embodiment are identical and are preferably bent axis, variable displacement, axial piston type pump motor units of the type disclosed in World Intellectual Property Organization publication number WO 2012/016240 A2, the disclosure of which is incorporated herein by reference. Alternatively, the size, displacement or type of the pump motor units 42 and 43 may be different from one another and/or may be different from that illustrated in the preferred embodiment. The pump motor units 42 and 43 each operate in a pumping (also called hydraulic regenerative braking) mode or in a motoring mode during the operation of the transmission 11. The primary pump rotor unit 42 is drivingly connected to primary pump motor unit drive shaft 44, and the secondary pump motor unit 43 is drivingly connected to secondary pump motor unit drive shaft 45. Pump motor unit drive shafts 44 and 45 are rotatably connected to wheels 15 through a planetary gear set 71. During the pumping or hydraulic regenerative braking mode, the units 42 and/or 43 operate to provide braking torque to wheels 15. In this mode, the units 42 and/or 43 are driven by primary pump motor unit drive shaft 44 and secondary pump motor unit drive shaft 45, respectively, to pump hydraulic fluid under pressure into a high pressure accumulator 46 through a hydraulic line 47 to store energy recovered during the braking mode. During the motoring mode, high pressure hydraulic fluid is supplied to the units 42 and/or 43 from high pressure accumulator 46 through hydraulic line 47 to rotate the shafts 44 and 45 to convert stored energy from accumulator 46 to rotational movement. The units 42 and 43 and various valves illustrated in FIG. 1 are controlled by hydraulic controls 130. Hydraulic controls 130 illustrated in FIG. 1 and controller 117 illustrated in FIG. 2 may be separate components as illustrated in the drawings or may be integrated into a single component.

Referring now to FIGS. 2-4, the vehicle 100 is an over the highway truck having a braking system 100a that includes a foundation braking system 111 (sometimes referred to as “FB” on the drawings) and a hydraulic regenerative braking system 112 and that operates according to a method 100b. In the illustrated embodiment, the foundation braking system 111 is, for example, a conventional truck air brake system. The hydraulic braking system 112 is a part of the hydraulic hybrid drive system for the vehicle 110 illustrated in FIG. 1 and may alternatively be of any desired configuration. As used herein, the term “foundation braking torque” means the braking torque applied by the vehicle's foundation braking system 111, which in the illustrated embodiment translates air pressure in air canisters to braking torque on the vehicle wheels. The term “hydraulic braking torque” is the torque applied by the vehicle's hydraulic regenerative braking system. The term “net torque” or “total torque” or “hydraulic and foundation brake torque blended” means the sum of hydraulic braking torque and foundation braking torque. The term “treadle pressure commanded torque” or “total commanded torque” means the braking torque commanded or requested by the vehicle operator as implied by brake pedal pressure.

The vehicle 100 can include any number of axles, and in the preferred embodiment of FIGS. 2-4 the vehicle 100 includes a front axle 113, an intermediate axle 114 and a rear axle 115. Each axle 113-115 includes at least one conventional actuator such as an air brake canister 113a, 114a, 115a, respectively, which are components of the foundation braking system. Each air brake canister is arranged so that an increase in air pressure in the canister applies the vehicle air brakes to the wheels of its associated axle, and the amount of air braking torque applied to each axle by the air brakes is dependent upon the amount of air pressure supplied to its associated canister. A treadle 116 receives as an input a force applied by the operator when the vehicle 100 is to be braked and provides as an output a total desired brake torque command signal that is communicated to a system electronic controller 117. The term “electronic controller” means an electric control device having active and/or passive electrical components. A pressure sensor 113b, 114b, 115b may be associated with each canister, to sense the air pressure in each canister and to transmit that pressure to the system electronic controller 117. The controller 117 receives various inputs, such as for example, the air pressure in each brake canister, the total brake torque command signal from the treadle valve 116, and hydraulic system inputs such as hydraulic accumulator fluid pressure and volume, hydraulic pump motor unit speed and displacement, vehicle speed, temperatures, and others. In response to those inputs, the controller 117 provides various outputs such as, for example, output command signals to the hydraulic controls 130 of hydraulic braking system 112 and output command signals to an electronically controlled treadle 116a.

The treadle 116a receives air under pressure from a conventional air tank and dryer 118 and communicates that air pressure to an on off solenoid valve or isolation valve 119 that operates in response to a command signal from controller 117 to its solenoid 119a. Treadle valve 116a is a proportional air pressure valve. The proportional treadle valve 116a has a variable orifice pressure reducing valve that preferable receives an input command signal from controller 117 and receives air from tank 118 and provides air pressure through solenoid valve 119 to canisters 113a, 114a, 115a that is proportional to the command signal from controller 117, so that a higher electrical current flow command signal to solenoid 119a causes a higher amount of air pressure to the canisters. Alternatively, treadle valve 116a could be an on off valve and solenoid valve 119 could be a proportional variable orifice pneumatic valve that provides air pressure to canisters 113a, 114a, 115a that is proportional to the command signal received by its solenoid 119a from controller 117. The electronic treadle 116a is also arranged with treadle valve 116, so that in the event electronic actuation of braking system 100a is not achieved by electronic treadle valve 116a in response to operator input, the operator input will actuate treadle valve 116 to provide actuation of air braking system 111.

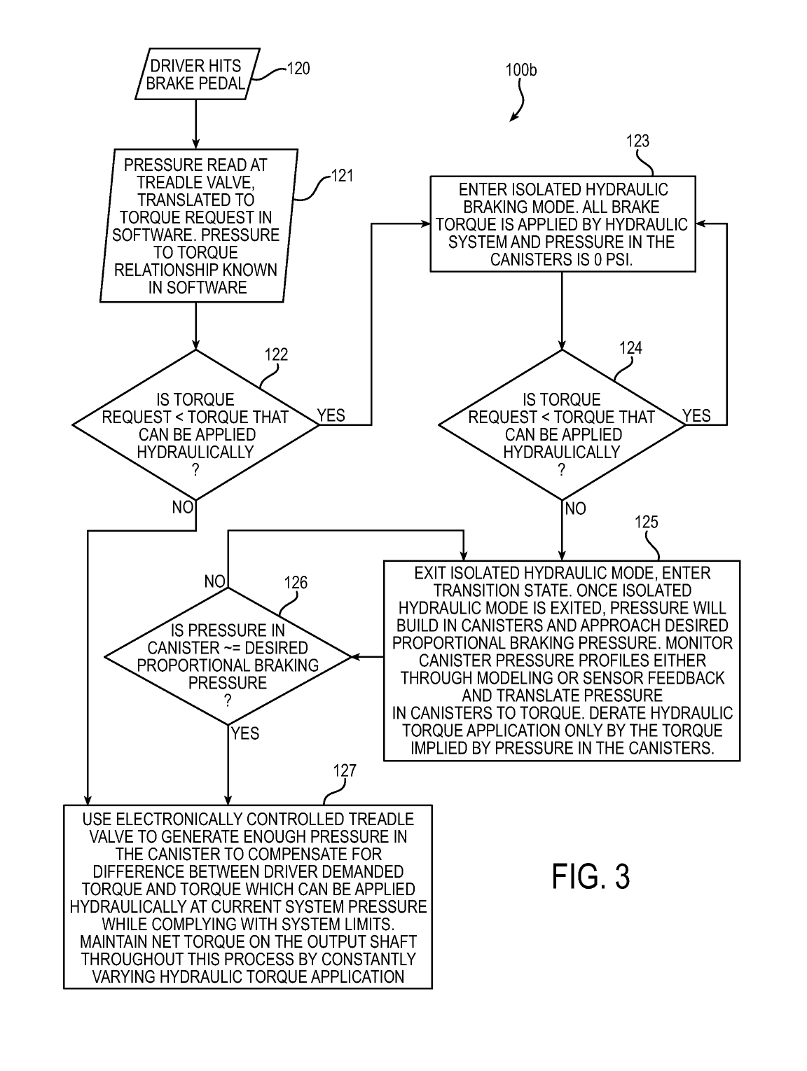

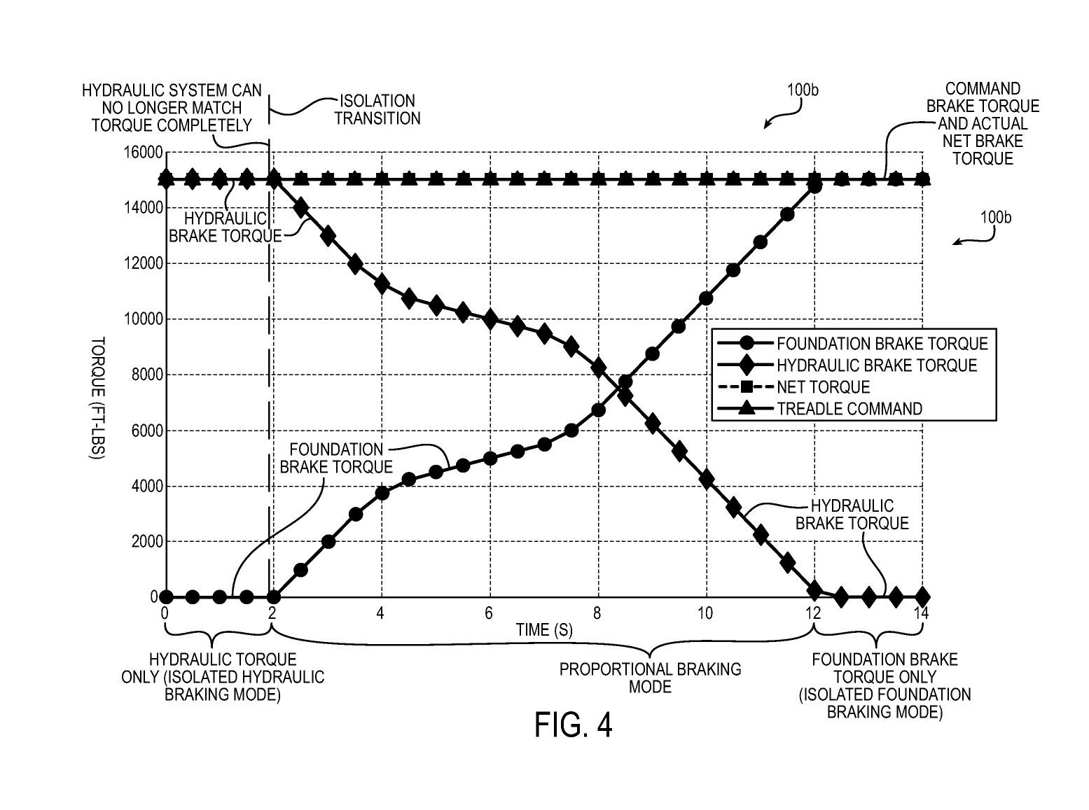

The operation of system 100a and method 100b according to the preferred embodiment of the invention is illustrated in FIGS. 3 and 4. The operator actuates the treadle 116 at step 120, resulting in an input command to controller 117. The input command can be electrically communicated directly from treadle 116, or can be provided by a pressure sensor that senses the commanded air pressure in the treadle 116. Controller 117 at step 121 determines the commanded or requested total braking torque implied or requested by the operator input, and in response to its inputs, determines if the hydraulic system has sufficient available energy storage and/or torque capacity to provide the total commanded braking torque. If the total commanded braking torque is less than the torque that can be applied hydraulically by the hydraulic brake system 112 at current accumulator pressure with current system limits based upon available energy storage capacity of the accumulator and other factors, the method moves to step 123 at an isolated hydraulic braking mode. All brake torque is applied by the hydraulic braking system 112 in the isolated hydraulic braking mode, and canister pressure is at 0 psi atmospheric pressure based upon an output command signal from controller 117 to treadle 116a. The controller 117 repeats step 122 at step 124 and maintains the isolated hydraulic braking mode.

If at step 124 the controller 117 determines that the requested total braking torque is not less than braking torque that can be applied hydraulically at current system pressure while complying with current system limits, the method proceeds to step 125. At step 125, the controller 117 commands an exit from the isolated hydraulic braking mode and begins to command solenoid 119a and treadle 116a to begin to supply air pressure to canisters 113a-115a. Once isolated hydraulic braking mode is exited, the braking system 10a moves to a proportional braking mode. In this mode, pressure will build proportionally in the foundation braking system canisters 113a-115a and approach the desired amount of canister air pressure required to provide actual foundation braking system 111 braking torque that is required to supplement the actual hydraulic braking system 112 braking torque. This is accomplished by controller 117 at step 125 monitoring foundation braking system 111 canister pressure profiles either through modeling (for example, implying commanded total braking torque by operator brake pedal 116 force and matching actual braking torque to commanded braking torque by modeling through known relationships between brake pedal force, known air pressure supplied to isolation valves such as isolation valve 119, and known pressure build versus time history in canisters 113a-115a after isolation valves open programmed into the controller 117) or through canister pressure sensor feedback (for example, through canister pressure sensors 113b-115b) and translates such modeled or actual pressure in the canisters 113a-115a to braking torque supplied by the foundation air braking system 111 (through known relationship between modeled or actual pressure in the canisters and foundation braking torque). Controller 117 at step 125 modulates the hydraulic braking system 112 to de-rate or decrease the hydraulic torque application if required, only by the foundation (air) braking system torque implied by the modeled or actual pressure in the canisters 113-115 or other indicia. Controller 117 at step 126 determines if modeled or measured pressure in the canisters 113-115 is about equal to the desired proportional air braking pressure needed to provide the desired proportional air braking system braking torque, and if not then step 125 is repeated until the desired pressure and proportional air braking torque is attained. The controller 117 may execute steps 122-126 at least in part by calculating the kinetic energy of vehicle 110 at its measured ground speed, determining if the hydraulic accumulator of the hydraulic braking system 112 can receive and store some or all of that energy in a manner that optimizes energy storage and minimizes heat generation, and commands foundation (air) braking only to the extent hydraulic braking would be undesirable, as further discussed below.

The method then proceeds to step 127 where controller 117 commands hydraulic braking torque to achieve a preferred combination of maximum anticipated or calculated probable energy storage and minimum anticipated or calculated probable hydraulic fluid heat build-up, and varies the hydraulic braking torque so that the sum of the hydraulic braking torque and the foundation braking torque implied by actual or modeled air braking pressure in the canisters 113a-115a equals the total commanded braking torque from treadle 116. Specifically, at step 127, electronically controlled treadle 116a generates enough pressure in the canisters 113a-115a to compensate for the difference between driver commanded torque and torque which can be applied by the hydraulic system 112 at current system conditions while complying with system limits. The net torque on the output shaft or axles is maintained throughout this process by constantly varying the hydraulic torque application imposed by the pump motor unit (not shown) of the hydraulic braking system 112. Controller 117 calculates a desired amount of proportional braking torque for each of the regenerative hydraulic braking torque from the hydraulic braking system 112 and the foundation braking torque provided by the foundation braking system 111 near the initiation of and substantially continuously during a braking event based at least in part upon sensed current energy storage capacity of the hydraulic braking system 112.

FIG. 4 illustrates one example of this proportional braking operation of system 100a and method 100b. In FIG. 4, the operator commanded total braking torque is first met (up until, for example, time value 2 on the horizontal axis) during the isolated hydraulic braking mode solely by the hydraulic system 112. When controller 117 determines that the available hydraulic braking may not be sufficient to provide the commanded total braking torque, controller 117 commands isolation valve 119 to open and commands proportional valve 110a to supply a foundation (air) braking torque to axles 113-115. Controller 117 also de-rates or decreases hydraulic braking (for example, through connection with hydraulic controls 130), so that the sum of the air braking torque and the hydraulic braking torque equals the operator commanded total braking torque. If hydraulic braking torque moves to 0, air braking torque solely will meet the commanded total braking torque (for example, after time value 2 on the horizontal axis) in the isolated foundation braking mode. As the system 100a and method 100b move through the various modes of operation, the actual braking torque remains substantially equal to commanded braking torque and remains substantially smooth and substantially constant. The slopes of the curves illustrated in FIG. 4 are examples and will change, based upon how fast the hydraulic braking torque decreases and how fast the air braking torque increases. By substantially constantly monitoring foundation braking torque through measured or modeled canister pressure and substantially constantly monitoring hydraulic braking torque (which may be changed very quickly by hydraulic controls 130), hydraulic braking torque is controlled to always be the difference between commanded braking torque and foundation braking torque. In this manner, a smooth braking event may be achieved during all conditions during and after exiting from isolated hydraulic braking mode. For this proportional braking, the treadle pressure may be used as an input to the controller 117 to provide proportional air brake pressure or air braking torque and hydraulic braking torque even at or near the initiation of a braking event (that is, at a time level between 0 and 2 on the horizontal axis of FIG. 4).

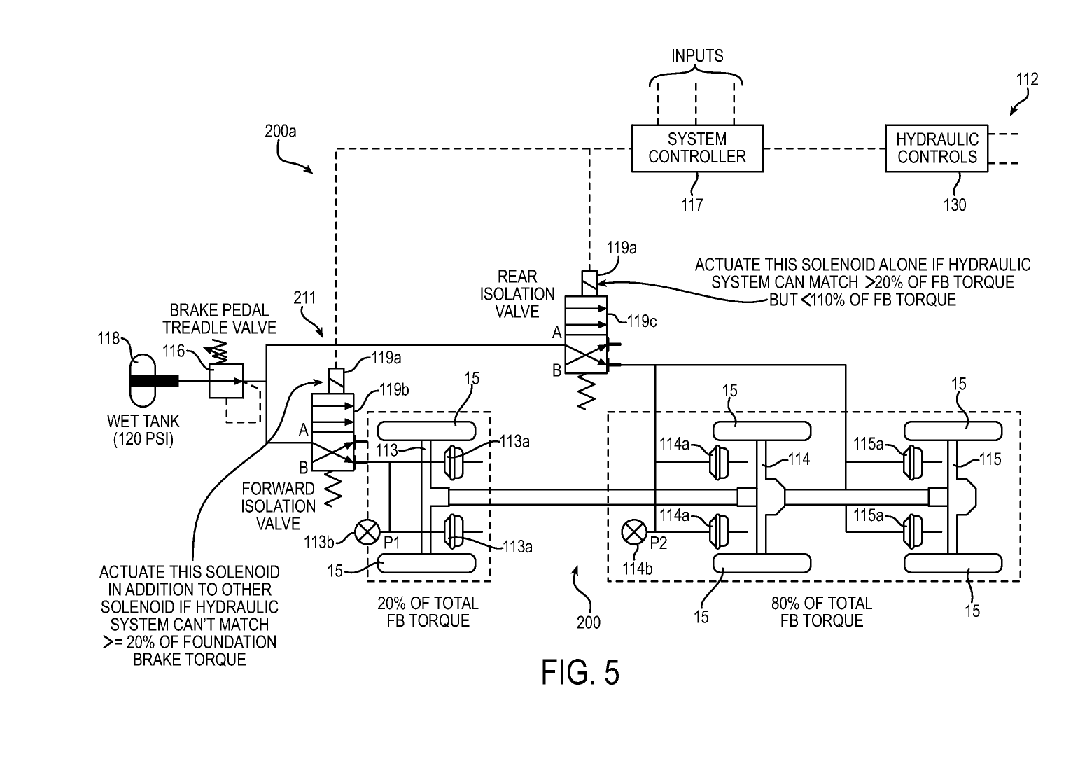

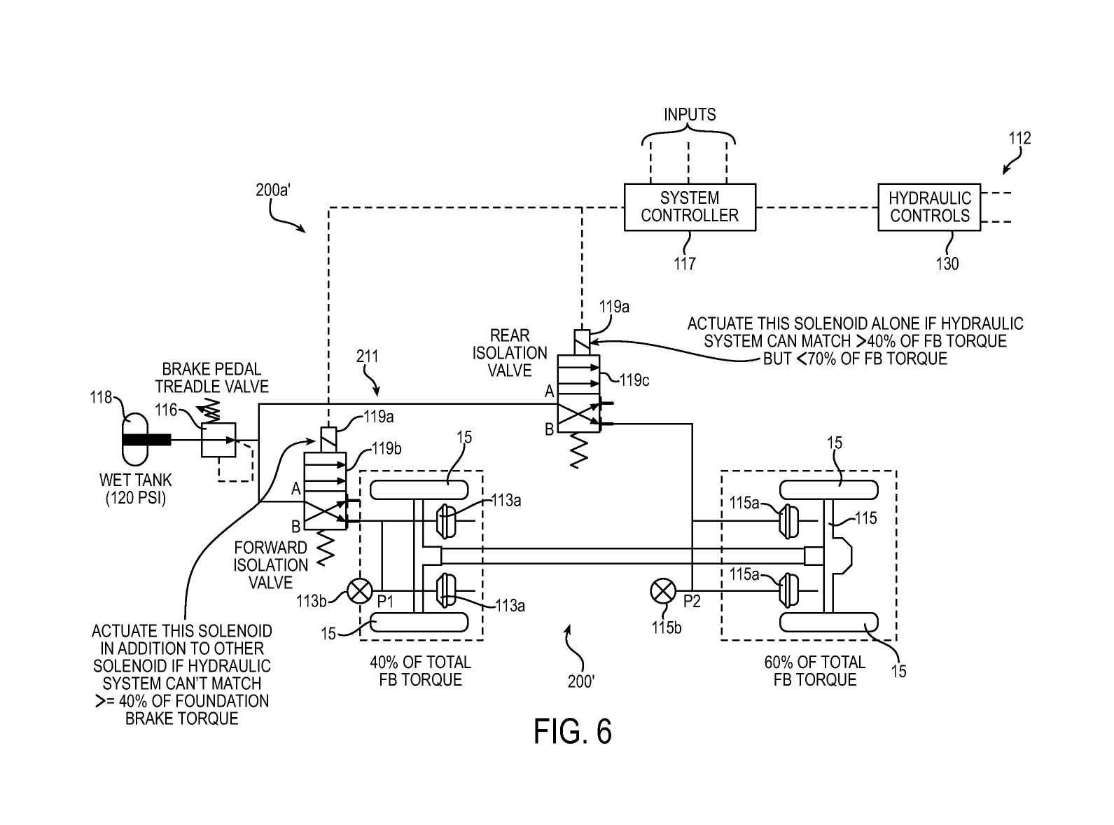

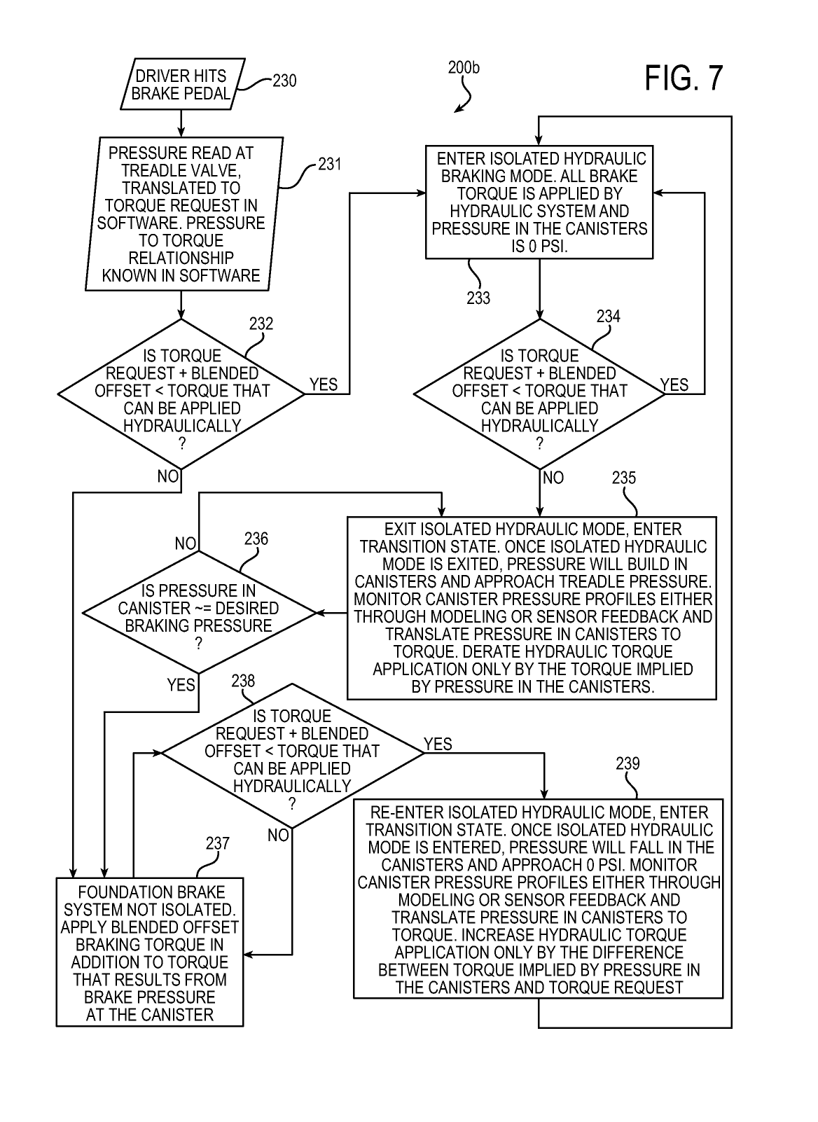

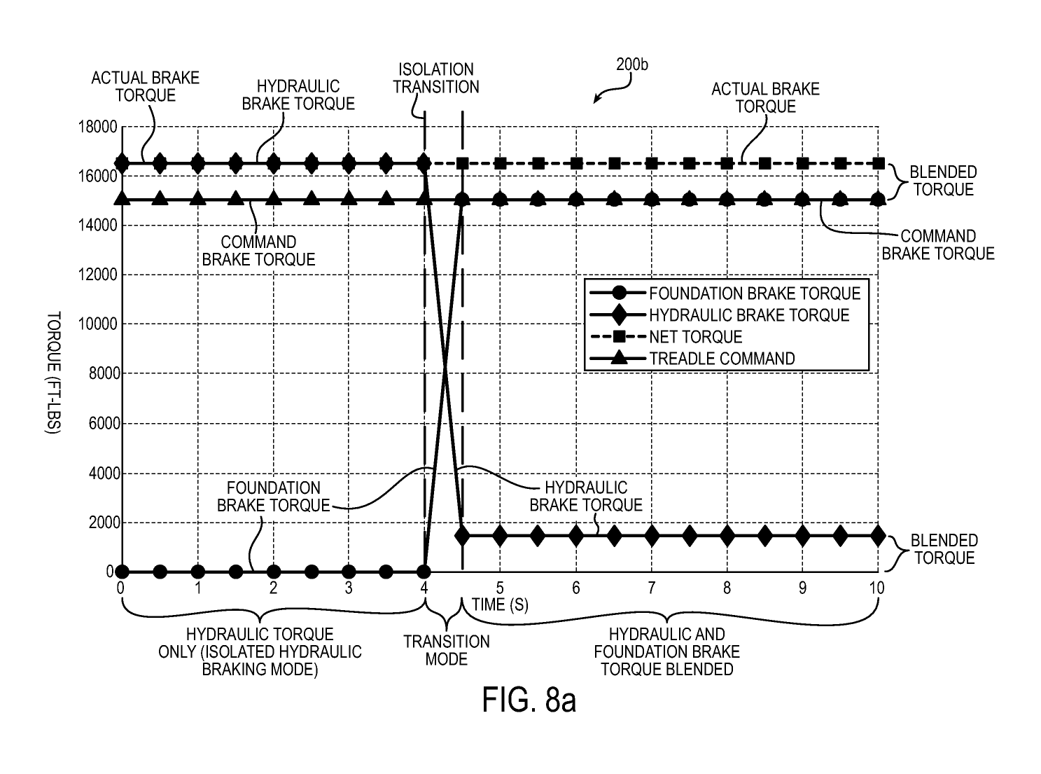

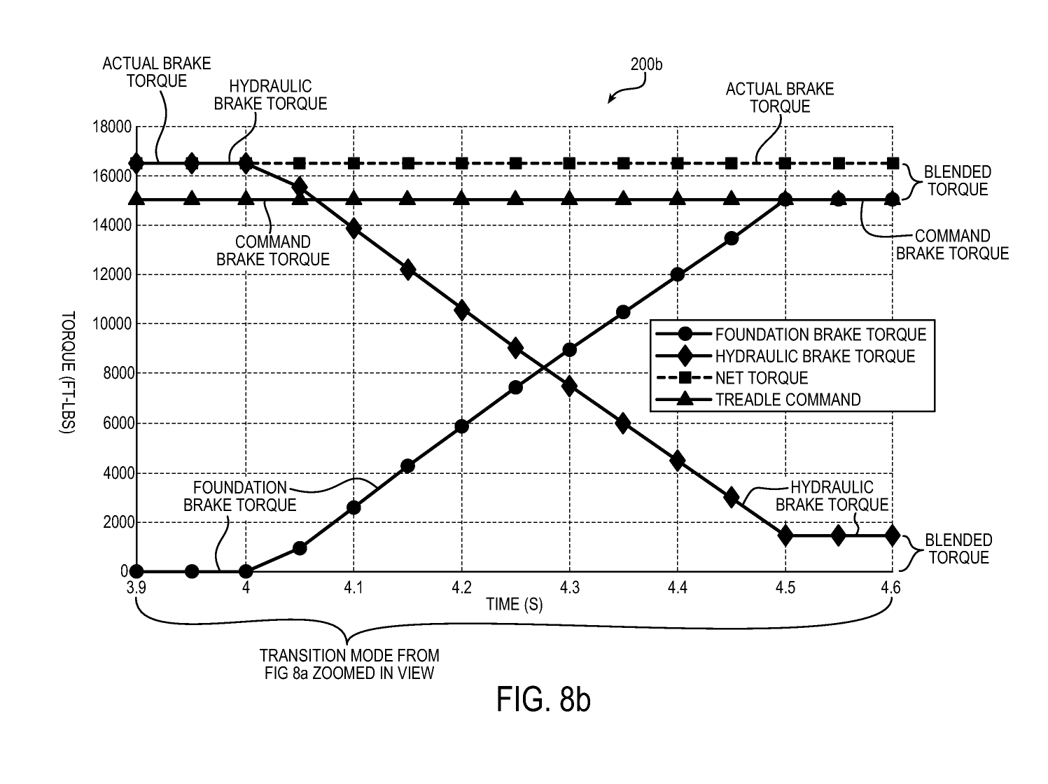

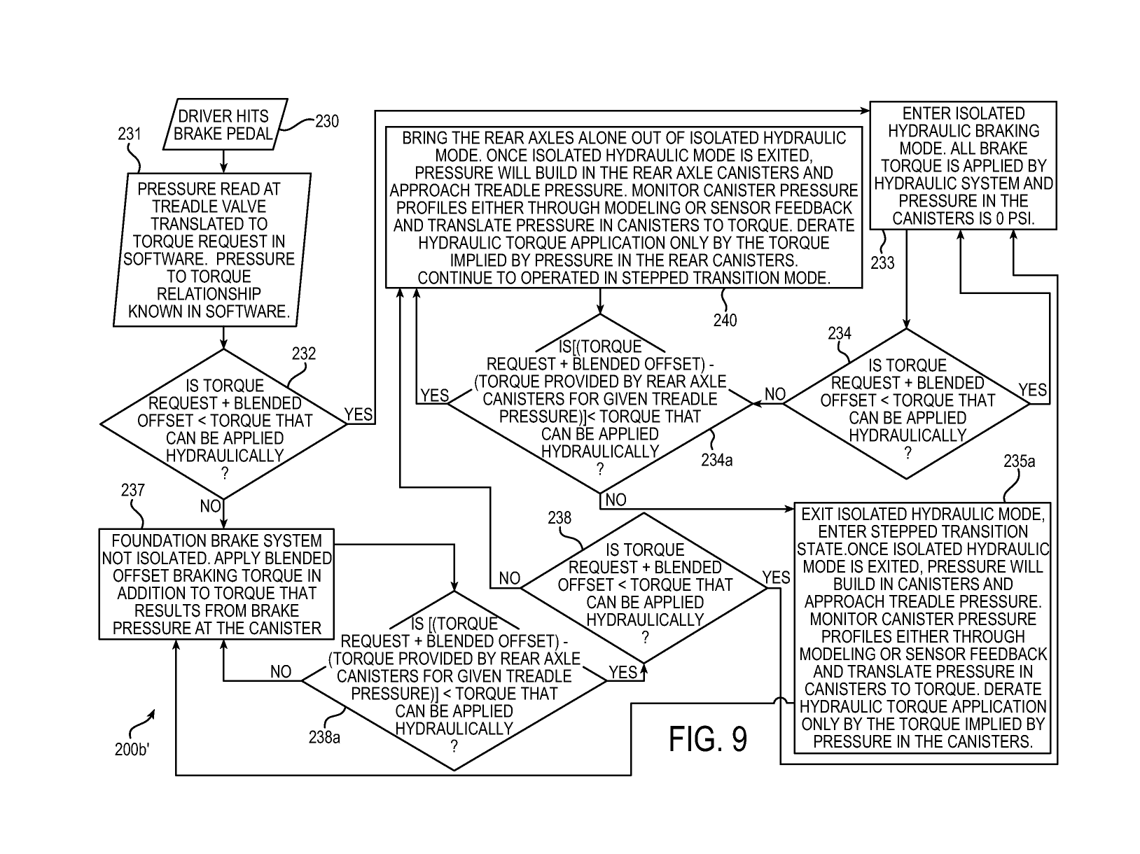

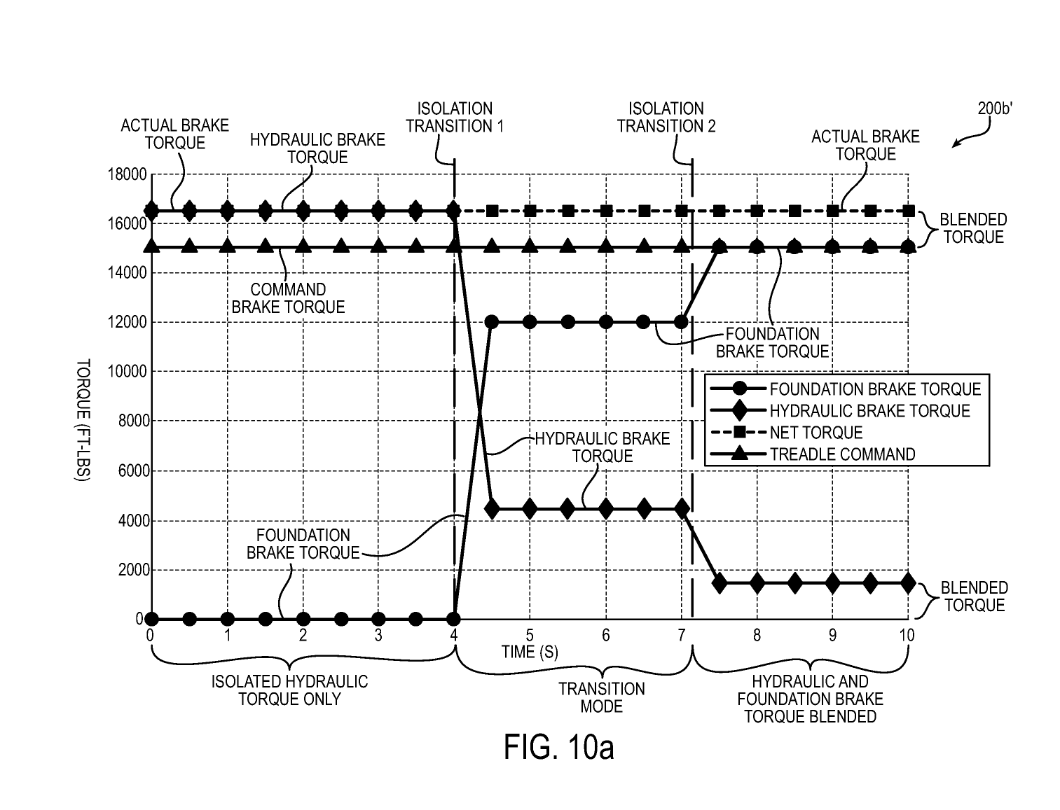

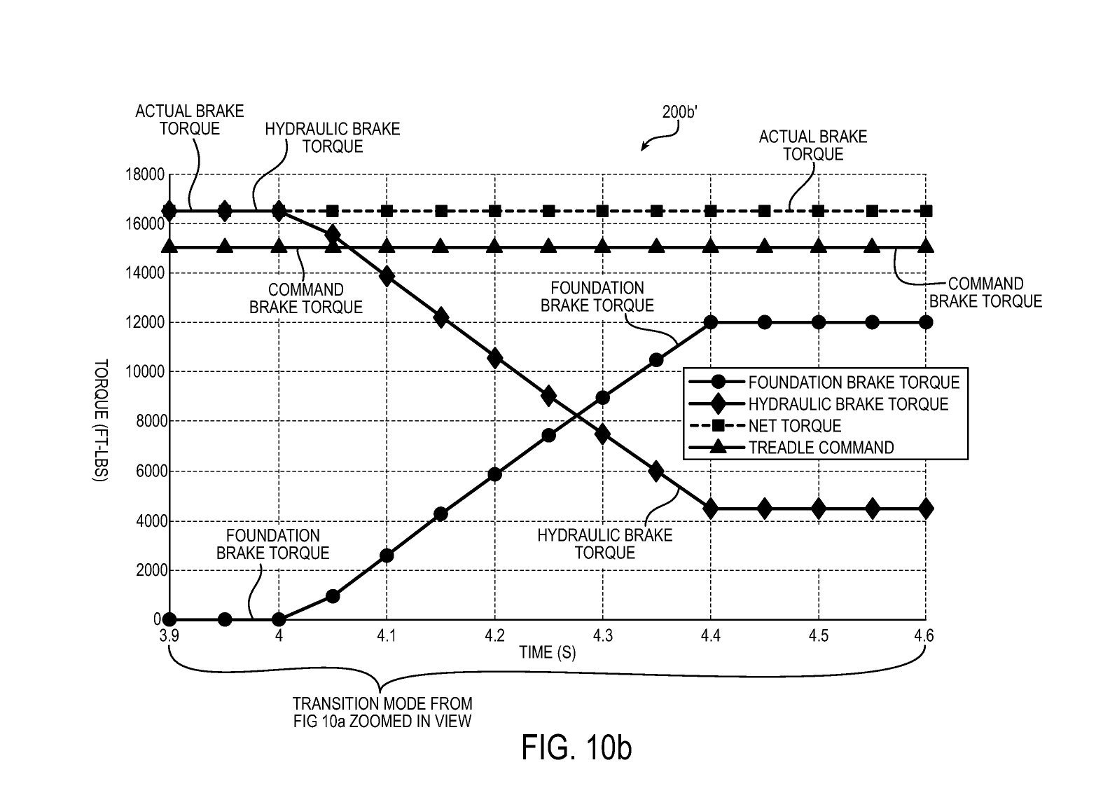

Turning now to FIGS. 5-10, a second embodiment of a wheeled land vehicle 200 (FIG. 5) or 200′ (FIG. 6) is illustrated, which can be of any desired configuration. In the illustrated embodiment, for example, the vehicle 200 or 200′ is an over the highway truck having a braking system 200a or 200a′ that includes a foundation braking system 211 and a hydraulic braking system 212 and that operate according to a method 200b (FIG. 7 and 8) or 200b′ (FIGS. 9 and 10). The system and method of FIGS. 5-10 is similar to that of FIGS. 2-4, and components in FIGS. 5-10 that are similar to components in FIGS. 2-4 are indicated with the same reference number with differences discussed below. FIG. 5 illustrates the second embodiment in a three axle vehicle 200, and FIG. 6 illustrates the second embodiment in a two axle vehicle 200′. FIGS. 5 and 6 illustrate typical percentage front and rear air or foundation braking torques, and these percentages are illustrated as examples and can be other percentages.

The system 200a (FIG. 5), 200a′ (FIG. 6) and method 200b (FIGS. 7 and 8) are not proportional systems and proportional methods as in FIGS. 2-4, but instead approximate a proportional system to provide a smooth transition exiting from an isolated hydraulic braking mode. The system 200a includes an operator actuated air brake treadle valve 116 but does not include a proportional valve such as valve 16a in FIGS. 2-4. In response to its inputs, the controller 117 provides various outputs such as, for example, output command signals to the hydraulic controls 130 of hydraulic regenerative braking system 112. The treadle 116 receives air under pressure from a conventional air tank and dryer 118 and communicates that air pressure to a front on off solenoid valve or isolation valve 119b and to a rear on off solenoid valve or isolation valve 119c. Valves 119b and 119c operate in response to a command signal from controller 117 to their solenoids 119a.

One exemplary operation of system 200a and method 200b is illustrated in FIGS. 7 and 8. FIG. 7 is a flow chart illustrating the method 200b. FIG. 8 is a graph of braking torque vs time, illustrating for the FIG. 7 flow chart the commanded braking torque, hydraulic braking torque, foundation braking torque, and net actual braking torque. FIGS. 7 and 8 illustrate operation with simultaneous actuation of isolation valves 119b and 119c as further discussed below. This operation is similar to that illustrated in FIGS. 3 and 4, except that system 200a and method 200b approximate but do not provide actual proportional operation and may not achieve the same efficiency and smoothness. The operator actuates the treadle 116 at step 230, resulting in an input command at step 231 to controller 117. The input command can be electrically communicated directly from treadle 116, or can be provided by a pressure sensor that senses the commanded air pressure ire the treadle 116. At step 232, controller 117 determines if the torque requested or commanded by the operator plus a predetermined torque increment amount referred to herein as “blended torque” or “blended torque” can be met by the hydraulic braking system. The amount of the blended torque is illustrated in FIG. 8 as the difference between commanded torque and actual torque during isolated hydraulic mode. This difference can be greater or less than the amount illustrated. If yes, then system 200a and method 200b proceed to step 233 to enter an isolated hydraulic mode of operation. At step 233, all braking torque is applied by the hydraulic system 112 and canister pressure is 0 atmospheric psi. At step 233, the hydraulic system 112 provides an actual hydraulic braking torque that is greater than the commanded braking torque by the blended offset amount. Step 234 determines if the hydraulic system by itself can maintain the total braking torque at the commanded braking torque plus the blended offset amount. The process continues in a loop of step 234 and 233 until controller 117 determines that the hydraulic capacity of the hydraulic system 112 cannot or soon will not be able to maintain this total braking torque.

When step 234 reaches a no condition, the system 200a and method 200b at step 235 exit the isolated hydraulic mode (for example, at time value 4 on the horizontal axis) and move to a transition mode. Controller 117 at step 235 commands valves 119b and 119c to open. This substantially immediately (over a time less than one second, for example) supplies an air braking torque to axles 113-115 that is equal to the commanded torque. Controller 117 also reduces or Berates hydraulic braking torque, so that the sum of the air braking torque and the hydraulic braking torque substantially equals the operator commanded total braking torque plus the blended offset amount. This may be accomplished by translating pressure at the air brake canister into a torque at the pump motor unit, and de-rating hydraulic braking torque as this feedback pressure increases. Because the actual braking torque during the isolated hydraulic braking mode exceeded the commanded total braking torque by the blended offset amount, the substantially immediate application of air braking torque that is less than this total, plus the commanded reduced hydraulic braking torque, together are about substantially the same as the actual braking torque during the isolated hydraulic braking rode. This results in a substantially constant actual braking torque across the transition mode, to provide smoother transition than would otherwise occur without use of the blended offset. At step 236, controller 117 determines if the pressure in the canisters is about equal to the commanded braking torque. If yes, then at step 237 the system 200a and method 200b continue in a blended hydraulic and air brake mode in which the air brake torque plus the hydraulic brake torque provides an actual braking torque that is equal to the commanded brake torque plus the blended offset amount. At step 238, controller 117 determines at the then current conditions if the commanded braking torque plus the blended offset is less than the torque that can be produced by the hydraulic braking only, and if yes then the system 200a and method 200b re-enter the hydraulic isolation ode at step 239.

As mentioned above, the amount of the blended offset torque can be greater or less than the amount illustrated in FIG. 8. The blended torque can approach or equal zero if desired. In this case, actual braking torque would be about equal to commanded braking torque. Foundation braking torque and hydraulic braking torque would still be substantially continuously monitored and controlled according to the invention, so that hydraulic braking torque would still provide the difference between commanded braking torque and actual braking torque for generally smooth operation upon exiting the isolated hydraulic braking mode. However, if the blended torque approaches or equals zero, the transition from isolated hydraulic braking mode to transition braking mode may not be as smooth as when the blended offset torque is an amount as illustrated in FIG. 8 for example.

A second alternate method 200b′ of operation of system 200a and 200a′ is illustrated in FIGS. 9 and 10. As further illustrated in FIGS. 9 and 10, the second alternate embodiment of the invention may further provide sequential operation of valves 119c and 119b to further enhance smooth operation and to further approximate proportional operation according to method 100b. Except as described below and illustrated in the flow chart of FIG. 9, FIG. 9 is similar to FIG. 7, and FIG. 10 is similar to FIG. 8 described above. Specifically, instead of opening the isolation valves 119c and 119b simultaneously at step 235 as described in connection with FIGS. 7 and 8, a stepped transition mode in method 200b′ may be entered upon exiting hydraulic isolation mode. For example, rear isolation valve 119c may be opened first by controller 117 upon exiting isolated hydraulic braking mode (for example, at time value 4 on the horizontal axis). This, for example, may apply the commanded air braking torque only to the intermediate and rear axles 114 and 115 in the case of a three axle vehicle or only to the rear axle 115 in the case of a two axle vehicle, for smoother operation at transition. Controller 117 may then again determine if hydraulic braking torque available plus foundation braking torque at axles 114 and 115 exceeds demand, and if not then controller 117 may open front valve 119b to also apply commanded air braking torque to front axle 113. The complete flow chart for this sequential or stepped transition mode is illustrated in FIG. 9, and the graph of various braking torques vs time for this sequential or stepped method is illustrated in FIG. 10. The same steps illustrated in FIG. 7 are indicated in FIG. 9 with the same reference number. Modified steps from FIG. 7 using the FIG. 9 stepped actuation of valves 119a, 119b and 119c are indicated in FIG. 9 with the same reference number with a suffix “a.”

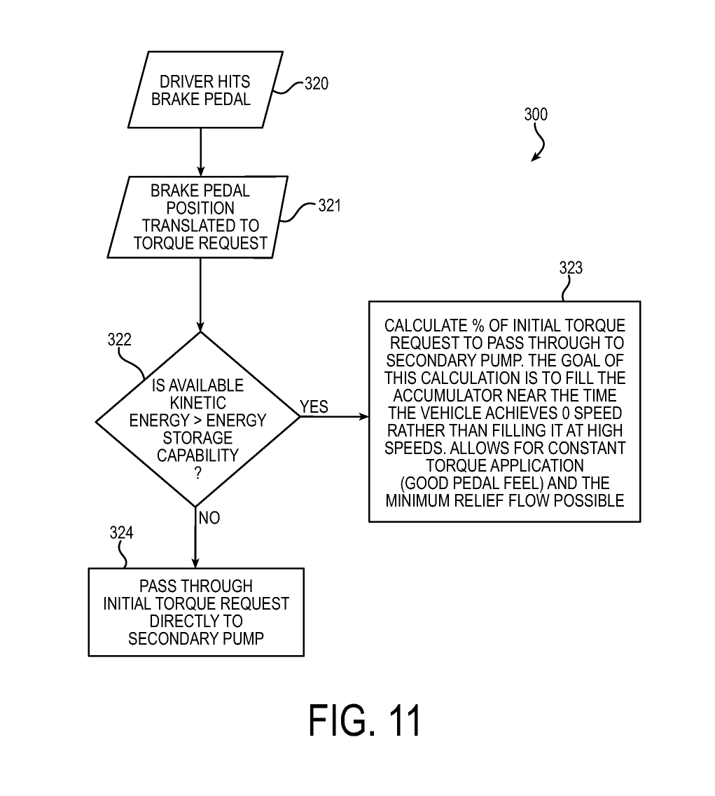

Referring now to FIG. 11, a method 300 according to a third embodiment of the invention is illustrated. The method 300 of FIG. 11 may be added to the system 100a or 200a or 200a′ described above and may be carried out in conventional brake systems or added to the methods 100b and 200b and 200b′ described above. Because the hydraulic hybrid regenerative braking systems illustrated herein have a finite energy storage capacity in the hydraulic pumping or braking mode, if the same hydraulic braking torque were to be applied at a 65 miles per hour vehicle ground speed as at a 25 miles per hour vehicle ground speed, for example, the hydraulic fluid accumulator energy storage device would reach its maximum energy storage capacity relatively quickly. Once the maximum energy storage capacity is reached, it would be necessary to push hydraulic fluid from the pump motor unit across a relief valve if further hydraulic braking were to be provided. This would generate a significant amount of undesirable heat in the hydraulic fluid. To address this technical problem, the invention further provides the method 300 illustrated in FIG. 11, which modifies the relationship at the initiation of a braking event between brake pedal or brake treadle or operator input and hydraulic braking torque based upon vehicle speed at the start of a braking event. Once a braking event is started, in one embodiment the described relationship is not further impacted. The method 300 may be used in braking systems and methods such as illustrated above in FIGS. 5-10. The above described solenoid valves or isolation valves 119b and 119c in such system may be eliminated for simplicity. In this simplified system and method 300, the controller 117 determines at the start of a braking event if hydraulic braking, or composite hydraulic braking with foundation (air) braking, will be used and then maintains that decision through the braking event.

According to the method 300, the vehicle operator at step 320 initiates a braking event by applying an input command to the treadle valve 116. The brake pedal position, or alternatively the force on the brake pedal or other indicia, is translated to a requested or commanded brake torque at step 321. At step 322, the controller 117, based upon the current system operating conditions including vehicle ground speed and hydraulic accumulator condition including pressure and fill level and temperature, determines if the kinetic energy of the vehicle is greater than the energy storage capacity of the hydraulic braking system 112. If no, the method 300 at step 324 applies 100% hydraulic braking for the entire braking event. If yes, the method 300 at step 323 determines the percentage or amount of the initial braking torque request to be provided by the hydraulic braking 112 through use of the hydraulic pump motor unit (not shown), and communicates this hydraulic braking torque as a command to the hydraulic system 112. This calculation is made by controller 117 based upon current system conditions, to approximate the amount of hydraulic braking that will fill the accumulator of the hydraulic braking system 112 near the time the vehicle achieves zero ground speed rather than filling the accumulator at higher speeds near the initiation of the braking event. This allows for constant total actual braking torque, to provide smooth braking and good brake pedal feel and to provide minimum relief flow.

Accordingly, various embodiments of the invention may substantially seamlessly transition from hydraulic regenerative braking torque to a combination hydraulic braking and air braking. This may be accomplished by translating pressure at the air brake canister into a torque at the pump motor unit, and de-rating hydraulic braking torque as this feedback pressure increases. The pressure at the canister can either be read through a pressure transducer or modeled in the controller. For proportional braking, rather than blocking or isolating treadle pressure from the canisters in an isolated hydraulic braking mode, the treadle pressure may be used as an input to the controller to provide proportional air brake pressure or air braking torque and hydraulic braking torque even at or near the initiation of a braking event. To avoid filling the accumulator in the early stages of a relatively higher speed brake event, various embodiments of the invention further approximate kinetic energy of the vehicle at the initiation of a brake event and, when isolated hydraulic braking is not expected for the entire brake event to 0 ground speed due to anticipated energy storage limitations, decrease hydraulic braking at the initial time of the braking event to avoid reaching energy storage capacity during such early stages.

Although the principles, embodiments and operation of the present invention have been described in detail herein, this is not to be construed as being limited to the particular illustrative forms disclosed. For example, the blended offset described in connection with FIGS. 5-10 may be used with the proportional system described in FIGS. 2-4, and the kinetic method described in connection with FIG. 11 may be used with either of both of the blended offset and the proportional system. Further, these embodiments may substitute an electric regenerative braking system in place of the hydraulic regenerative braking system. With this electric regenerative braking system, the hydraulic accumulator (which is an energy storage device) would be replaced with an electric battery or ultra-capacitor (which are also energy storage devices), and the pump motor unit (which is a device for converting energy to torque and torque to energy) would be replaced with an electric motor generator (which is also a device for converting energy to torque and torque to energy). Both electric and hydraulic and other hybrid braking systems may operate in an “isolated regenerative braking mode,” with only the regenerative braking used to brake the vehicle. Further, it may be necessary to transition during a “transition braking mode” from the isolated regenerative braking mode to a “combination braking mode” or “blended braking mode” or “transition braking mode” that provides combined regenerative braking and foundation braking and/or to an “isolated foundation braking mode” in which only foundation braking is used. It will thus become apparent to those skilled in the art that various modifications of the embodiments herein can be made without departing from the spirit or scope of the invention.

1. A method of controlling a vehicle braking system comprising the steps:
providing a regenerative braking system with
an energy storage device, and
an energy to mechanical torque to energy conversion device connected to wheels of the vehicle to provide regenerative braking torque to wheels of the vehicle and connected to the energy storage device to store energy generated by the regenerative braking torque;
providing a foundation braking system with foundation braking actuators having fluid chambers to provide foundation braking torque to wheels of the vehicle;
providing an electronic controller in communication with each of the regenerative braking system and the foundation braking system;
storing in the controller a known relationship between foundation braking actuator chamber pressure and foundation braking torque;
sensing an input command based upon operator input and translating operator input to a total commanded braking torque;
sensing the available energy storage capacity of the energy storage device;
calculating a desired amount of braking torque for each of the regenerative braking torque and the foundation braking torque during a braking event based at least in part upon:
available energy storage capacity, and
vehicle ground speed,
communicating to the regenerative braking system a commanded regenerative braking torque to achieve the desired regenerative braking torque;
and communicating to the foundation braking system a commanded foundation braking torque to achieve the desired foundation braking torque.

2. A method of controlling a vehicle braking system as set forth in claim 1, including:
determining if total commanded braking torque is less than available regenerative braking torque based upon sensed available energy storage capacity of the energy storage device;
if yes, then entering an isolated regenerative braking mode in which substantially all braking torque is applied by the regenerative braking system and foundation braking torque is substantially zero and pressure in foundation braking system chambers is substantially zero atmospheric.

3. A method of controlling a vehicle braking system as set forth in claim 2, including:
if no, then using electronic controller to calculate and command required pressure in foundation braking system chambers to provide foundation braking torque substantially equal to difference between total commanded braking torque and available regenerative braking system braking torque at current regenerative braking system available energy storage capacity, and maintaining net braking torque substantially equal to total commanded braking torque by constantly varying the regenerative braking system braking torque.

4. A method of controlling a vehicle braking system as set forth in claim 2, including:
after entering isolated regenerative braking mode repeatedly determining if total commanded braking torque is less than available regenerative braking torque based upon sensed energy storage capacity of the energy storage device;
if yes, then continuing in isolated regenerative braking mode;
if no, then commanding required pressure in foundation braking system chambers to provide foundation braking torque substantially equal to difference between total commanded braking torque and available regenerative braking system braking torque at current regenerative braking system available energy storage capacity; and maintaining net braking torque by constantly varying the regenerative braking system braking torque.

5. A method of controlling a vehicle braking system as set forth in claim 1, wherein the calculating a desired amount of braking torque for each of the regenerative braking torque and the foundation braking torque during a braking event is based at least in part upon pressure in the foundation braking actuator chamber.

6. A method of controlling a vehicle braking system as set forth in claim 5, wherein pressure in the foundation braking actuator chamber is sensed without measuring pressure, by sensing operator input.

7. A method of controlling a vehicle braking system as set forth in claim 5, wherein pressure in the foundation braking actuator chamber is sensed by measuring pressure with a pressure sensor.

8. A method of controlling a vehicle braking system as set forth in claim 1, wherein the calculating a desired amount of braking torque for each of the regenerative braking torque and the foundation braking torque during a braking event includes calculating by operation of the controller a proportional amount of braking torque for each of the regenerative braking torque and the foundation braking torque.

9. A method of controlling a vehicle braking system as set forth in claim 8, including:
going to proportional braking mode upon exiting isolated regenerative braking mode;
in proportional braking mode, the operator input communicates a total commanded torque to the system controller; the system controller determines the available hydraulic torque based upon system inputs including available energy storage device storage capacity; the controller also determines the torque difference between the total commanded torque from the operator input and the actual regenerative torque commanded, and commands a proportional valve to provide pressure to the chamber that will result in the torque difference being applied through the foundation braking system; the controller continues to command both regenerative braking based upon regenerative system requirements and foundation braking based upon this difference, to allow use of maximum available regenerative braking.

10. A method of controlling a vehicle braking system as set forth in claim 9, wherein the foundation braking system is an air braking system, and the proportional valve is a proportional air pressure valve that controls the pressure in the chamber in response to controller input.

11. A method of controlling a vehicle braking system as set forth in claim 1, wherein the calculating a desired amount of braking torque for each of the regenerative braking torque and the foundation braking torque includes after exiting an isolated regenerative braking mode allowing pressure to build in the foundation braking actuator chamber to create a foundation braking torque, monitoring the pressure, and derating the regenerative braking torque by the foundation braking torque implied by the pressure.

12. A method of controlling a vehicle braking system as set forth in claim 11, including blocking foundation braking torque from the front wheels of the vehicle during a first stage of the transition mode.

13. A method of controlling a vehicle braking system as set forth in claim 12, including opening foundation braking torque to the front wheels of the vehicle during a second stage of the transition mode.

14. A method of controlling a vehicle braking system as set forth in claim 1, including adding a blended torque to the total commanded braking torque to provide a total actual braking torque;
commanding the regenerative braking system to provide regenerative braking torque substantially equal to the total actual braking torque during an isolated regenerative braking mode;
commanding the foundation braking system to provide substantially the total commanded braking torque and decreasing the commanded regenerative braking torque during a transition braking mode; and
maintaining the total actual braking torque substantially equal to the blended torque plus the total commanded braking torque during and after the transition braking mode.

15. A method of controlling a vehicle braking system as set forth in claim 14, including commanding the foundation braking system to provide a foundation braking torque substantially equal to the total commanded braking torque and commanding the regenerative braking system to provide a regenerative braking torque substantially equal to the blended torque after the transition braking mode.

16. A method of controlling a vehicle braking system as set forth in claim 14, including decreasing the commanded regenerative braking torque during the transition braking mode substantially to the blended torque.

17. A method of controlling a vehicle braking system as set forth in claim 1, including sensing the vehicle ground speed and using the vehicle ground speed to indicate the approximate kinetic energy of the vehicle;
comparing the energy storage device available energy storage capacity and the kinetic energy at the initiation of a brake event;
if energy storage capacity is greater than kinetic energy at the initiation of a braking event, then command the regenerative braking system to provide regenerative braking of the vehicle;
if energy storage capacity is less than kinetic energy at the initiation of a braking event, then command the regenerative system to provide actual regenerative braking torque in an amount to approximately fill the energy storage device capacity over time from initiation of the braking event to projected 0 ground speed at a given total commanded braking torque at initiation of the braking event; and
commanding the foundation braking system to provide foundation braking torque equal to the difference between the total commanded braking torque and the actual regenerative braking torque.

18. A method of controlling a vehicle braking system as set forth in claim 1, wherein the foundation braking system is an air braking system.

19. A method of controlling a vehicle braking system as set forth in claim 1, wherein the regenerative braking system is a hydraulic regenerative braking system, the energy storage device is a hydraulic accumulator, and the conversion device is a hydraulic pump motor unit.

20. A method of controlling a vehicle braking system comprising the steps:
providing a regenerative braking system with
an energy storage device having an energy storage capacity, and
a braking torque to energy to braking torque conversion device connected to wheels of the vehicle to provide regenerative braking torque to wheels of the vehicle and connected to the energy storage device to store energy expended to provide the regenerative braking torque;
providing a foundation braking system with
foundation braking actuators to provide foundation braking torque to wheels of the vehicle;
providing an electronic controller in
communication with each of the regenerative braking system and the foundation braking system;
sensing the available energy storage capacity of the energy storage device;
sensing the vehicle ground speed and using the vehicle ground speed to calculate the approximate kinetic energy of the vehicle;
comparing the energy storage device available energy storage capacity and the kinetic energy at the initiation of a brake event;
if energy storage capacity is greater than kinetic energy at the initiation of a braking event, then command the regenerative braking system to provide isolated regenerative braking of the vehicle;
if energy storage capacity is less than kinetic energy at the initiation of a braking event, then command the regenerative system to provide actual regenerative braking torque in an amount to approximately fill the energy storage device capacity over time from initiation of the braking event to projected 0 ground speed at a given total commanded braking torque at initiation of the braking event; and
commanding the foundation braking system to provide foundation braking torque equal to the difference between the total commanded braking torque and the actual regenerative braking torque.

21. A method of controlling a vehicle braking system as set forth in claim 20, wherein the foundation braking system is an air braking system.

22. A method of controlling a vehicle braking system as set forth in claim 21, wherein the regenerative braking system is a hydraulic regenerative braking system, the energy storage device is a hydraulic accumulator, and the conversion device is a hydraulic pump motor unit.

23. A system for carrying out the method of claim 1.

24. A vehicle including the system of claim 23.
